(19) United States
(12) Patent Application Publication
(10) Pub. No.: US 2010/0316455 A1
(43) Pub. Date: Dec. 16, 2010

(54) Vacuum Attachment for a Rotary Tool

(76) Inventor: Bernardo N. Sanchez, Toronto (CA)

Correspondence Address: GOWAN INTELLECTUAL PROPERTY, 1075 NORTH SERVICE ROAD WEST, SUITE 203, OAKVILLE, ON, L6M-2G2, CA

(21) Appl. No.: 12/521,620

(22) PCT Filed: Dec. 28, 2007
(86) PCT No.: PCT/CA2007/002366

§ 371 Date: Jun. 29, 2009

Related U.S. Application Data
(60) Provisional application No. 60/882,794, filed on Dec. 29, 2006.

(51) Int. Cl. B27C 9/00

(52) U.S. Cl. 408/58

(57) ABSTRACT

A vacuum attachment for attachment to a rotary tool such as a drill is provided, wherein the vacuum attachment comprises a housing, a vacuum section having an air flow means powered by the rotary tool, a dust and debris collection area having an opening at one end, and which is separated from said air flow means by a filtering device located at a second end, and a rotary tool connection device connecting said air flow means to said rotary tool, wherein said connection device is directly connected to said rotary tool such that rotation of said rotary tool effects rotation of said air flow means. The vacuum attachment also preferably contains a rotation assembly comprising gears and/or belts and pulleys, which is used to increase the rotational speed of the air flow means to a value greater than the rotational speed of the drill. The vacuum attachment can be used to collect minor amounts of dust and debris generated by, for example, the use of the rotary tool.

### FIELD OF THE INVENTION

The present invention relates to the field of rotary tool attachments, and in particular, relates to a vacuum attachment for a drill.

### BACKGROUND OF THE INVENTION

On numerous occasions, a tradesman, homeowner or the like, will use a rotary tool such as a drill for various reasons, and invariably will create a small collection of dust and debris from the drill operation. In order to clean up the debris, it is commonly necessary to sweep the floor, or use a regular sized vacuum cleaner to vacuum the area. This usually involves carrying the cleaning tools to the job site and then returning the clearing tools to their storage area after cleaning is complete.

It would therefore be desirable to provide a cleaning option which could be more easily implemented after the drilling (or any other operation) was complete.

In the prior art, there are numerous vacuum attachments to be attached to a rotary tool, such as a drill, in order to collect dust and debris. These typically, however, involve the use of a regular vacuum cleaner, with its own motor and the like, which is attached to the drill housing a shroud or cover, and which collects the dust and debris as it is being produced. Examples of this arrangement can be seen in U.S. Pat. No. 6,200,075 or 6,887,146.

A further example of a dust and debris collection device for a drill can be seen in U.S. Pat. Nos. 4,209,069, 5,772,367, 5,199,501 and 3,850,254 all of which provide vacuum attachments which are powered by the rotary tool, but are still used in combination with the drill in order to collect the dust and debris generated during the drilling operation. However, these devices decrease the portability of the drill, add additional size and weight to the drill, and are not conveniently used to clean up the job site after the drilling operation is complete.

Accordingly, it would still be advantageous to provide a vacuum attachment for a drill which could be used for cleaning of the job site once the drilling operation is complete.

### SUMMARY OF THE INVENTION

Accordingly, it is a principal advantage of the present invention to provide a rotary tool attachment that acts as a vacuum cleaner.

It is a further advantage of the present invention to provide such a rotary tool attachment which is directly connected to the rotary tool without the drill bit, or other operational element of the rotary tool, being in place.

The advantages set out hereinabove, as well as other objects and goals inherent thereto, are at least partially or fully provided by the vacuum attachment for a rotary tool, of the present invention, as set out hereinbelow.

Accordingly, in one aspect, the present invention provides a vacuum attachment for attachment to a rotary tool characterised in that the vacuum attachment comprises a housing, a vacuum section having an air flow means powered by the rotary tool, a dust and debris collection area having an opening at one end, and is separated from said air flow means by a filtering device at a second end, and a rotary tool connection device connecting said air flow means to said rotary tool, wherein said connection device is directly connected to said rotary tool such that rotation of said rotary tool effects rotation of said air flow means.

Optionally and preferably, the rotary tool connection device is connected to said air flow means through a rotation assembly, and the rotation assembly acts to increase the rotational speed of the air flow means to a speed greater than that of the rotary tool. In a drill with a drill bit attachment chuck, the rotational speed of the air flow means is preferably increased to a speed greater than the rotational speed of the drill chuck. As such, the speed of a fan shaft connected to the air flow means at the output end of the rotation assembly, is greater than the speed of the input (or chuck) shaft at the input end of the rotation assembly.

By being directly connected, the input shaft is preferably inserted directly into, positioned, and ultimately held within the drill's chuck assembly, using whatever chuck locking device is provided on the drill chuck.

Commonly, the rotational speed of a drill is typically less than 750 rpm, although some models can go up to 1500 rpm, or higher. Thus, the rotational speed of the air flow means is preferably increased to a speed greater than this value. However, the device of the present invention can also be used with a variable speed drill; with the speed of the air flow means being preferably increased to a speed greater than the rotational speed of the rotary tool.

In a preferred embodiment, the rotational speed of the fan shaft for the air flow means is at least 1.1 times the rotation speed of the input shaft and/or the rotary tool. More preferably, the speed of the fan shaft of the air flow means is greater than 3 times the rotation speed of the input shaft and/or the rotary tool. Still more preferably, the speed of the fan shaft of the air flow means is greater than 25 times, and even more preferably, greater than 100 times the speed of the input shaft and/or the rotary tool.

The upper limit of the speed increase will be limited based on the construction materials used, the device size, and the like, and the skilled artisan will readily appreciate how to control and/or limit the maximum speed of the fan shaft and/or air flow means.

Further, the air flow means and optional rotation assembly, are preferably contained within said housing bearings such that said housing is stationary during rotation of said air flow means.

In a further aspect, the present invention also provides a rotary tool powered vacuum assembly comprising a rotary tool, and a vacuum assembly as herein described with respect to the present invention, directly attached thereto. The rotary tool is preferably a drill, and the vacuum assembly is preferably attached in the absence of any other functional element, such as a drill bit, being attached to the rotary tool.

### DETAILED DESCRIPTION OF THE INVENTION

In the present application, the term “rotary tool” refers to any suitable rotary tool. This includes devices such as drills, rotary powered screwdrivers, and the like. Most commonly, though, the rotary tool will be a drill that accepts drill attachments, such as drill bits, using a “chuck” mounting system. The chuck can be operated using a traditional chuck key, or using a keyless system commonly provided on more recent drills.

The rotary tool, or drill, can be a traditional corded model, or can be a cordless model operating off of a battery power supply. The tool might also be powered by any other suitable means, such as a pneumatic powered rotary tool. The rotary tool might be a fixed speed device, or can be a variable speed device.

Primarily, however, the present application is primarily directed to the use of a drill. As such, the present invention will be described with particular reference to a drill application, however, the skilled artisan will be aware that the present application is equally applicable in any suitable rotary tool application

### BRIEF DESCRIPTION OF THE DRAWINGS

Embodiments of this invention will now be described by way of example only in association with the accompanying drawings in which:

FIG. 1 is a perspective drawing of an embodiment of a rotary tool vacuum attachment of the present invention;

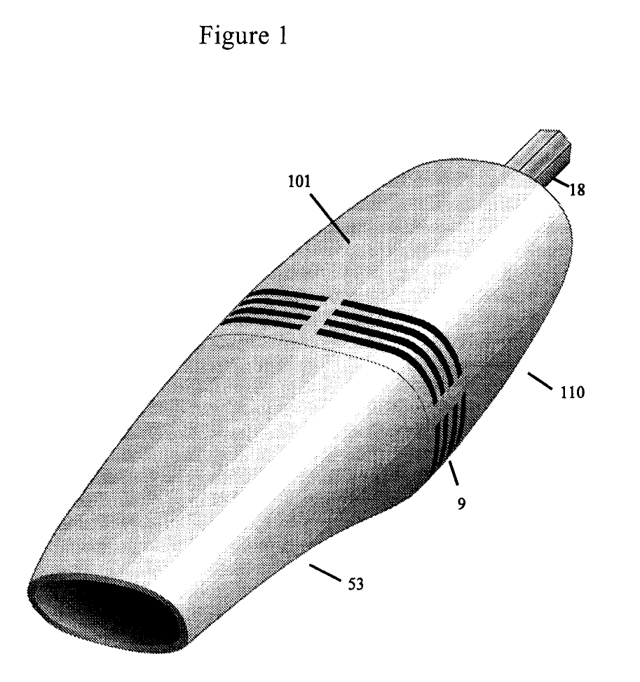

FIG. 2 is a cross-sectional view of the attachment of FIG. 1;

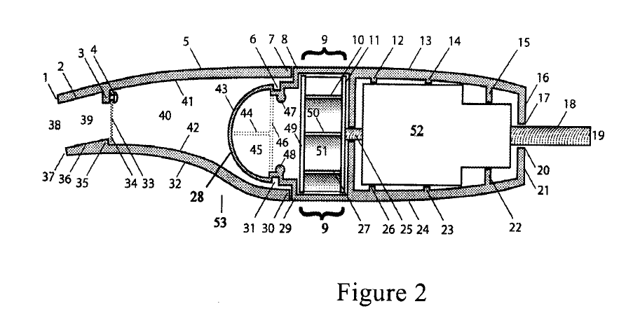

FIGS. 3A, 3B and 3C are cross-sectional views of different rotational assemblies;

FIG. 4 is an end view of one of the planetary gear assemblies of FIG. 3A; and

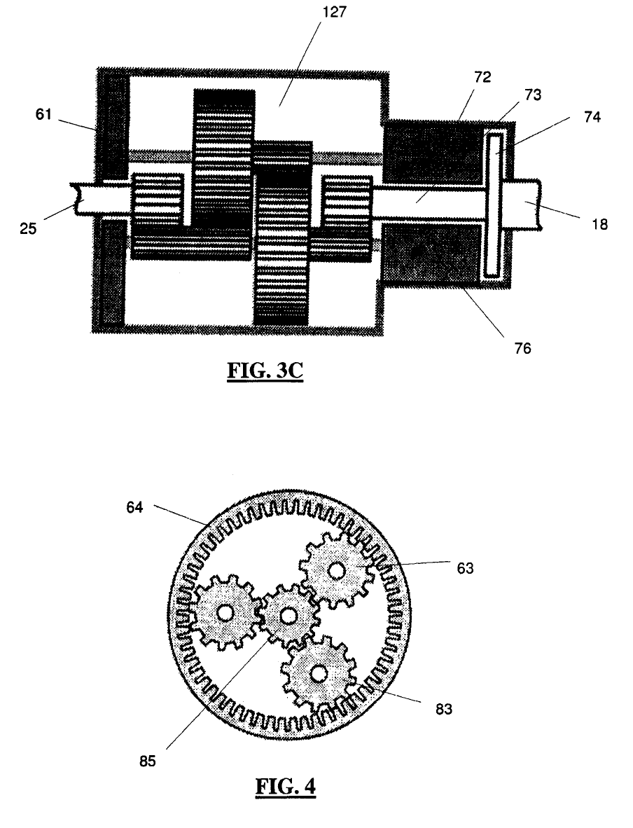

FIG. 5 is a view of the vacuum attachment of FIG. 1 shown when connected to a drill as a rotary tool.

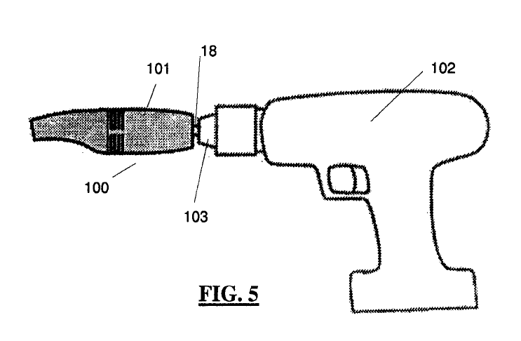

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention.

Referring to the figures, a vacuum attachment 100 having a housing 101 and a chuck attachment shaft 18, for attachment to a rotary tool such as a drill 102, is shown. Vacuum attachment 100 is attached to the drill by insertion of the input or chuck attachment shaft 18 into the chuck 103 of drill 102.

Drill 102 is operated in a normal fashion in order to effect rotation of the fan 51 which acts as the air flow means. In this embodiment, fan 51 is a turbine fan although any suitable fan shape or design might also be utilized.

Fan 51 draws air through nozzle opening 38, and through filter 28 which rests on filter support 43. Filter 28 can be any suitable material such as a screen, a fiber mat, or the like. Dust and debris collected through nozzle opening 38 is prevented from passing through the attachment by filter 28, and therefore collects in collection cavity 40. It is also prevented from falling back through the nozzle, by optional flexible one way valve 33 fitted to support 3.

The air that has passed through filter 28 exits the device through vents 9 spaced around the perimeter of housing 101.

Fan 51 is operatively connected to input/chuck attachment shaft 18 using a rotation assembly 52, which as previously described, preferably increases the speed of fan 51 to a speed greater than the speed of chuck 103.

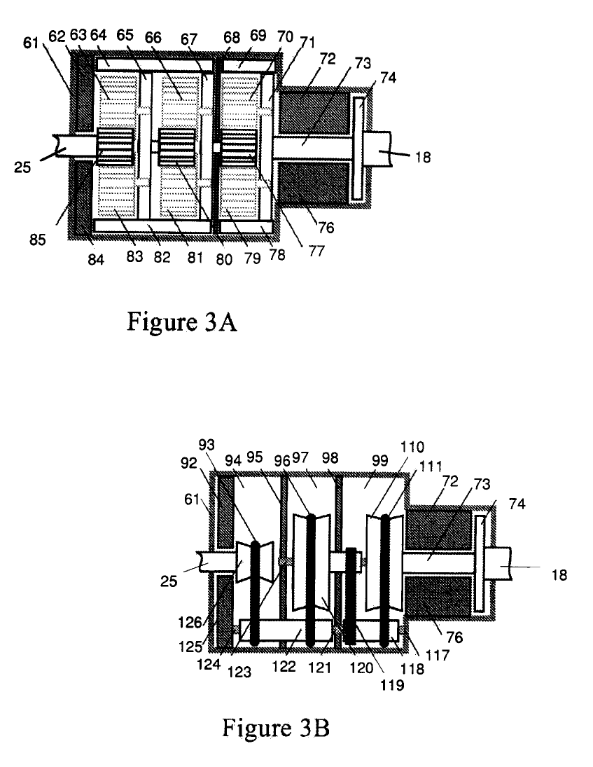

Several possible embodiments of various rotation assemblies 52 are shown in FIGS. 3A, 3B and 3C. The rotation assemblies 52 of FIG. 3A uses a planetary gear arrangement, while the rotation assembly of FIG. 3B uses a series of belts and pulleys. In FIG. 3C, a series of offset gears 127 is shown.

Other arrangements for the assembly of rotation assembly would be clearly known to the skilled artisan, and any suitable arrangement might be used. Preferably, however, the rotational speed of fan shaft 25 is increased in rotation assembly 52 so as to be greater than the rotational speed of input/chuck attachment shaft 18.

As such, in a drill for example, the typically higher speed of the motor has been reduced in the drill housing in order to provide a reduced drill bit speed which has increased torque. In the use of the present invention, gearing is therefore preferably provided in order to increase the speed of the air flow means.

Also, in this embodiment, the components of rotation assembly 52 and fan 51 are supported by various bearings, and thus are free to rotate within housing 101. As such, housing 101 remains stationary.

Housing 101 comprises a series of parts including a nozzle assembly 53 that houses a removable collection cavity 40. Nozzle assembly 53 is removable, so that the dust and debris collected by vacuum attachment 100, can be removed.

A parts listing for the various components shown in the figures is as follows, and additional details of construction are provided therein:

### PART LISTING

1—top edge of nozzle opening
2—inner top edge of nozzle opening, parallel to 36 to allow for extension and attachment insertion
3—support across entire cavity for one-way valve (33)
4—pin securing one-way valve (33) to support (3)
5—dorsal (top) of nozzle component
6—groove (top) for securing filter, continuous with 31
7—connecting edge (top) of nozzle component to body component
8—connecting edge (top) of body component to nozzle component
9—vented area for fan (51) exhaust (around entire body)
10—fan (51) blade edge
11—fan (51) rear flange
12—forward support for rotatation assembly, continuous with 26
13—dorsal (top) body component
14—center support for rotatation assembly, continuous with 23
15—rear support for rotatation assembly, continuous with 22
16—back of body component, cropped for chuck rotation
17—top edge of circular opening for chuck attachment shaft (18)
18—input/chuck attachment shaft
19—end of input/chuck attachment shaft (18) for insertion into chuck
20—bottom edge of circular opening for input/chuck attachment shaft (18)
21—back of body component, cropped for chuck rotation
22—rear support for rotatation assembly, continuous with 15
23—center support for rotatation assembly, continuous with 14
24—anterior (bottom) body component
25—fan (51) shaft
26—forward support for rotatation assembly, continuous with 12
27—fan (51) blade edge
28—filter
29—connecting edge (bottom) of body component to nozzle component
30—connecting edge (bottom) of nozzle component to body component
31—groove (bottom) for securing filter, continuous with 6
32—anterior (bottom) of nozzle component
33—flexible one-way valve
34—bottom of one-way valve (33), allowed inward (towards 40) motion but prevented from outward (towards 38) motion by lip (35)
35—lip holding one-way valve (35)
36—inner bottom edge of nozzle opening, parallel to 2 to allow for extension and attachment insertion
37—bottom edge of nozzle opening
38—nozzle opening
39—entrance cavity of nozzle component
40—collection cavity of nozzle component
41—top inner edge of collection cavity (40) of nozzle component
42—bottom inner edge of collection cavity (40) of nozzle component
43—forward leading edge of filter support
44—crossbeam of filter support (arc behind and in front of plane of diagram), attaches to leading edge (43) and base ring (46) of filter support
45—post-filter, pre-fan (51) low pressure cavity of body component
46—base ring of filter support (perpendicular to plane of diagram)
47—structural contact point for body component
48—structural contact point for body component
49—fan (51) forward flange
50—fan (51) blade edge
51—fan, attached to fan shaft (25)
52—rotation assembly
53—nozzle assembly
61—casing for rotation assembly
62—bearing for fan shaft (86), continuous with 84
63—planet gear for third planetary
64—ring gear shared by second and third planetaries, continuous with 82
65—planet carrier for third planetary
66—planet gear for second planetary
67—planet carrier for second planetary
68—lubricated washer(s)
69—ring gear for first planetary, continuous with 78
70—planet gear for first planetary
71—planet carrier for first planetary
72—bearing for drive shaft (73), continuous with 76
73—drive shaft
74—drive shaft (73) flange
76—bearing for drive shaft (73), continuous with 72
77—sun gear for first planetary
78—ring gear for first planetary, continuous with 69
79—sun gear for first planetary
80—sun gear for second planetary
81—planet gear for second planetary
82—ring gear shared by second and third planetaries, continuous with 64
83—planet gear for third planetary
84—bearing for fan shaft (25), continuous with 62
85—sun gear for third planetary
92—bearing for fan shaft (25)
93—fourth belt
94—belt cavity for fourth belt (93)
95—wall
96—third belt
97—belt cavity for third belt (96)
98—wall
99—belt cavity for first and second belts (111,119)
110—first belt (111) pulley
111—first belt
117—bearing and shaft for first (118) and second (122) rollers, continuous with 121 and 124
118—first roller, free rotating around roller shaft (121)
119—second belt (flat)
120—second belt (119) and third belt (9) pulley, free rotating around pulley shaft (123)
121—roller shaft, continuous with 117 and 124
122—second roller, free rotating around roller shaft (121)
123—pulley shaft
124—bearing and shaft for first (118) and second (122) rollers, continuous with 117 and 121
125—bearing for fan shaft (127), continuous with 92
126—third pulley, driven by fourth belt (93) and attached to fan shaft (25)
127—offset gears

Thus, it is apparent that there has been provided, in accordance with the present invention, a vacuum attachment for use with a rotary tool, and in particular, a drill, which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

We claim:

1. A vacuum attachment for attachment to a rotary tool wherein the vacuum attachment comprises a housing, a vacuum section having an air flow means powered by the rotary tool, a dust and debris collection area having an opening at one end, and which is separated from said air flow means by a filtering device located at a second end, and a rotary tool connection device connecting said air flow means to said rotary tool, wherein said connection device is directly connected to said rotary tool such that rotation of said rotary tool effects rotation of said air flow means.

2. A vacuum attachment as claimed in claim 1 wherein said rotary tool connection device is connected to said air flow means through a rotation assembly, and wherein the rotation assembly acts to increase the rotational speed of the air flow means to a speed greater than that of the rotary tool.

3. A vacuum attachment device as claimed in claim 1 wherein said rotary tool is a drill having a drill chuck, and said rotary tool connection device is a input shaft which is inserted into said drill chuck so as to be positioned and held within said drill chuck.

4. A vacuum attachment device as claimed in claim 3 wherein said air flow means is connected to a fan shaft exiting said rotation assembly, and the rotational speed of said fan shaft is greater than the rotational speed of said input shaft.

5. A vacuum attachment device as claimed in claim 4 wherein the rotational speed of said fan shaft is at least 1.1 times the rotation speed of said input shaft.

6. A vacuum attachment device as claimed in claim 4 wherein the rotational speed of said fan shaft is greater than 3 times the rotation speed of said input shaft.

7. A vacuum attachment device as claimed in claim 4 wherein the rotational speed of said fan shaft is greater than 25 times the rotation speed of said input shaft.

8. A vacuum attachment device as claimed in claim 4 wherein the rotational speed of said fan shaft is greater than 125 time the rotation speed of said input shaft.

9. A vacuum attachment device as claimed in claim 2 wherein said air flow means and said rotation assembly, are contained within said housing bearings such that said housing is stationary during rotation of said air flow means.

10. A vacuum attachment device as claimed in claim 1 wherein said rotary tool is a drill having a chuck mounting system for accepting drill attachments.

11. A vacuum attachment device as claimed in claim 1 wherein said air flow means is a turbine fan.

12. A vacuum attachment device as claimed in claim 1 wherein said housing comprises a nozzle opening, a collection cavity, and a one way valve that allows dust and debris to only pass one way through said nozzle opening into said collection cavity.

13. A vacuum attachment device as claimed in claim 2 wherein said rotation assembly comprises offset gears, planetary gears, or a series of belts and pulleys.

14. A rotary tool powered vacuum assembly comprising a rotary tool, and a vacuum attachment device as claimed in claim 1, wherein said vacuum attachment device is directly attached thereto.
